(19) United States
(12) Patent Application Publication
(10) Pub. No.: US 2014/0066027 A1
(43) Pub. Date: Mar. 6, 2014

(54) SYSTEM FOR GENERATING A RECORD OF WHETHER A PERSON IS OPERATING A VEHICLE WHILE COMPOSING AN ELECTRONIC MESSAGE

(71) Applicants: Roger A. Fratti, Mohnton, PA (US); James R. McDaniel, Nazareth, PA (US)

(72) Inventors: Roger A. Fratti, Mohnton, PA (US); James R. McDaniel, Nazareth, PA (US)

(21) Appl. No.: 13/598,932

(22) Filed: Aug. 30, 2012

(51) Int. Cl. H04W 4/12

(52) U.S. Cl. 455/414.1

(57) ABSTRACT

An apparatus comprising an interface and a control circuit. The interface may be configured to allow a user to compose an electronic message. The control circuit may be configured to (i) receive motion information during a time when a user composes the electronic message and (ii) embed the motion information within the electronic message in a format readable along with the electronic message.

### FIELD OF THE INVENTION

The present invention relates to electronic messaging generally and, more particularly, to a method and/or apparatus for generating a record of whether a person is operating a vehicle while composing an electronic message.

### BACKGROUND OF THE INVENTION

Electronic messaging using portable devices has become very popular in recent years. Composing an electronic message while operating a vehicle (such as an automobile, bus, boat, tractor/trailer, skateboard, all-terrain vehicle, bicycle, etc.) is generally considered to be quite dangerous. Conventional approaches to deterring composing electronic messages while operating a vehicle include commercials showing the adverse effects of accidents. Laws have also been passed that strictly prohibit composing electronic messages while operating a vehicle. However, such commercials and laws are not always effective. People seem to continue to “text and drive”.

It would be desirable to implement a system for generating a record of whether a person is operating a vehicle while composing an electronic message.

### SUMMARY OF THE INVENTION

The present invention concerns an apparatus comprising an interface and a control circuit. The interface may be configured to allow a user to compose an electronic message. The control circuit may be configured to (i) receive motion information during a time when a user composes the electronic message and (ii) embed the motion information within the electronic message in a format readable along with the electronic message.

The objects, features and advantages of the present invention include providing a system that may (i) generate a record of the relative motion of the person composing an electronic message, (ii) generate a record of whether a person is operating a vehicle while composing an electronic message (iii) embed GPS location information into an electronic message, (iv) embed velocity information into an electronic message, and/or (v) be implemented in a portable device.

### BRIEF DESCRIPTION OF THE DRAWINGS

These and other objects, features and advantages of the present invention will be apparent from the following detailed description and the appended claims and drawings in which:

FIG. 1 is a block diagram of an example implementation of the invention;

FIGS. 2A and 2B are diagrams of a portable device;

FIG. 3 is a flow diagram of the present invention;

FIG. 4 is a more detailed flow diagram of the present invention;

FIG. 5 is a flow diagram of an example of how to calculate motion information;

FIG. 6 is an alternate example of how to calculate motion information;

FIG. 7 is an alternate example of how to calculate motion information; and

FIGS. 8A and 8B are diagrams illustrating sample electronic messages.

### DETAILED DESCRIPTION OF THE PREFERRED EMBODIMENTS

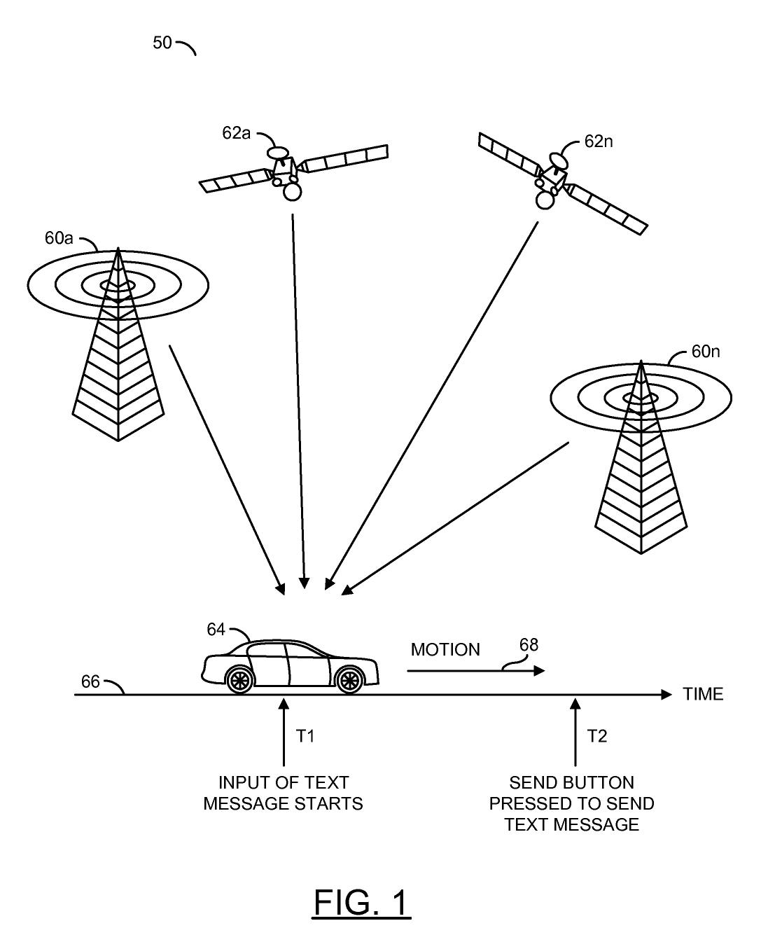

Referring to FIG. 1, a block diagram of a system 50 is shown illustrating a context of an embodiment of the present invention. The system 50 generally comprises a number of towers 60a-60n, a number of global positioning satellites 62a-62n, a vehicle 64 and a road 66. The vehicle 64 may be, but is not limited to, an automobile, bus, tractor/trailer, boat, skateboard, all-terrain vehicle, bicycle, etc. An arrow 68 generally represents the motion of the vehicle 64. An arrow T1 generally represents a time when an electronic message is initiated. The electronic message may be, but is not limited to, a text message, e-mail, etc. An arrow T2 generally represents a time when, for example, a send button is pressed to initiate the completion and/or sending of the electronic message. While two cellular towers 60a-60n are shown, and two satellites 62a-62n are shown, the particular number of towers 60a-60n and/or satellites 62a-62n may be varied to meet the design criteria of a particular implementation.

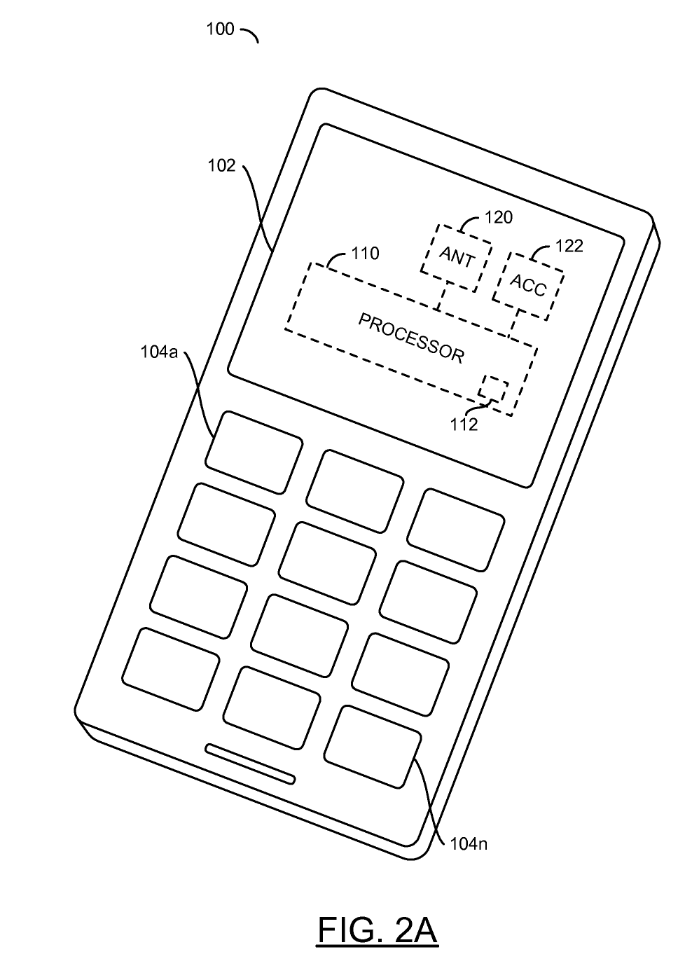

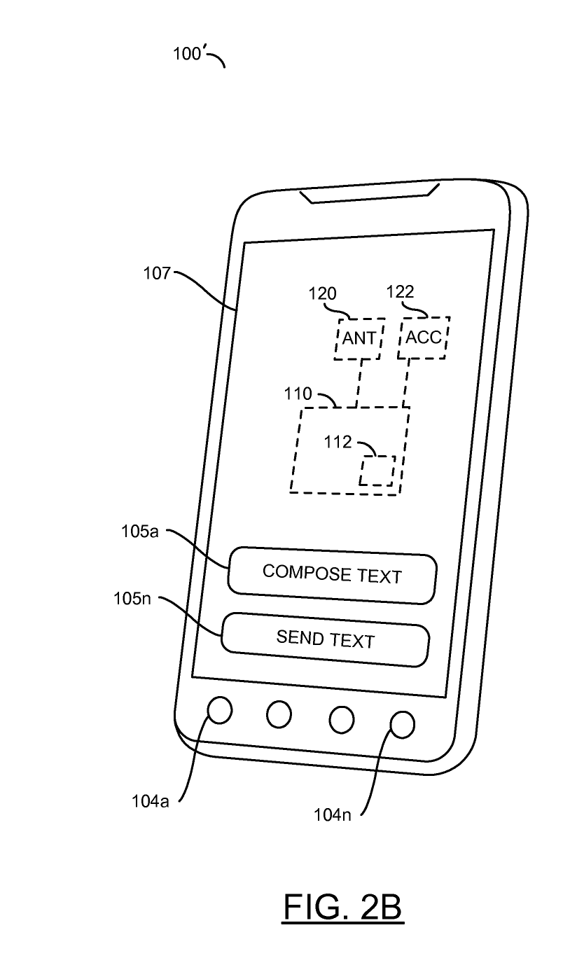

Referring to FIGS. 2A and 2B, diagrams of a portable device 100 are shown. The portable device 100 may be implemented, in one example, as a cellular telephone, a smart phone, or other type of portable computing device (e.g., tablet, etc.). In another example, the device 100 may be part of an electronics suite of the vehicle 64. For example, the device 100 may be embedded in the dashboard of a car or truck and may use the navigation screen available on many such vehicles.

The device 100 generally comprises a display 102 and a number of buttons (or keys) 104a-104n, and a block (or circuit) 110. In the device 100′ of FIG. 2B, a number of soft buttons 105a-105n are shown. The soft buttons may be implemented, for example, as part of a touchscreen 107. The circuit 110 may be implemented as a processor. The processor 110 may include a block (or circuit) 112. The circuit 112 may be implemented as a memory circuit. The memory 112 may store computer instructions that, when executed, provide a variety of the steps and/or calculations described. The processor 110 may also include inputs from an antenna 120 and/or an accelerometer 122. In one example, the antenna 120 may be implemented as a global positioning system (GPS) antenna. The antenna 120 may also operate as a cellular antenna. While a single antenna 122 is shown that may operate on both the GPS band (e.g., a first frequency range) and the cellular band (e.g., a second frequency range), in certain design implementations, two antennas may be implemented. In one example, GPS information may be obtained from the GPS satellites 62a-62n. However, in another example, position information be obtained directly from the cellular towers 60a-60n.

The device 122 may be implemented as an accelerometer. In one example, the accelerometer 122 may be implemented as a micro electromechanical systems (MEMS) accelerometer. However, the particular type of accelerometer implemented may be varied to meet the design criteria of a particular implementation. In general, the accelerometer 122 may be small enough to fit within a typical portable device 100 (e.g., without adding to weight and/or cost). The device 100 may use the accelerometer preset in many smart phones (e.g., iPhone, etc.).

The accelerometer 122 may be used to collect motion information about the vehicle 64 at one or more of the times T1, T2, etc. Such motion information may be appended to the electronic message to document the relative motion of the device 100. In one example, the accelerometer 122 may be used to append motion information regarding the location of the user at the time T1 (e.g., the beginning of the electronic message). The accelerometer 122 may also be used to append motion information regarding the location of the user at the T2 (e.g., the end of the electronic message). The relative speed of the device 100 may then be determined based upon these two data points. In this manner, an operator analyzing data from the device 100 (e.g., an insurance adjuster, actuary, etc.) may determine if the device 100 was in motion while the electronic message was being composed.

A calculation of the speed of the device 100 may be generated in a number of ways. For example, the processor 110 may read the X, Y, Z coordinates from the accelerometer 122. In another example, the GPS antenna 120 may be used to obtain two GPS data points. In another example, a speed parameter may be calculated based on a triangulation of signals received from cellular towers 60a-60n.

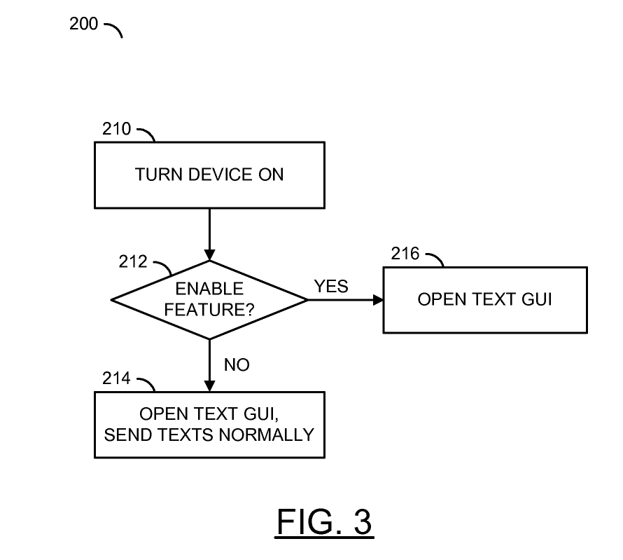

The device 100 may be implemented as a short message service (SMS) enabled device capable of sending electronic messages. The GPS antenna 120 and/or the accelerometer 122 may be used to generate and/or record the relative motion of the device 100 at a number of times. A graphical user interface (GUI) may be modified to append relative motion information to electronic messages (to be described in more detail in connection with FIGS. 3-8). The device 100 may collect and/or record a log of safe and/or legal electronic messaging. Such a log may have value for truck drivers, sales people, and/or other mobile people that need to communicate via electronic messaging. Insurance companies may use the log from the device 100 to modify rates, apply discounts for safe driving, etc.

Referring to FIG. 3, a flow diagram of the method (or process) 200 is shown. The method 200 may include a step (or state) 210, a decision step (or state) 212, a step (or state) 214 and a step (or state) 216. The state 210 may represent when the device 100 is turned on. The state 212 may allow a user to enable or disable the features of the device 100. If the decision state 212 selects the features to not be enabled, the method 200 moves to the state 214, and the device 100 may operate normally. If the decision state 212 selects the features to be enabled, the method 200 moves to the state 216, and the device 100 may, for example, open the graphical user interface (not shown) on device 100.

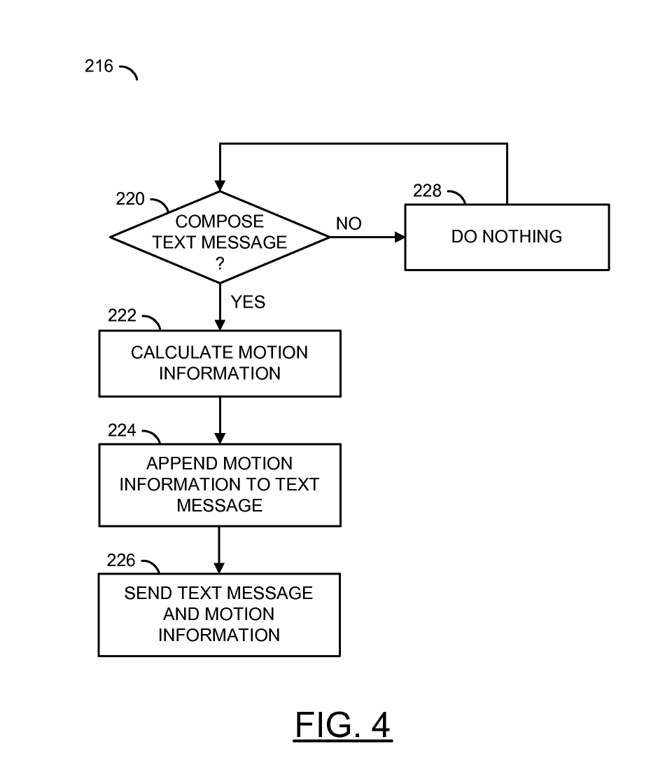

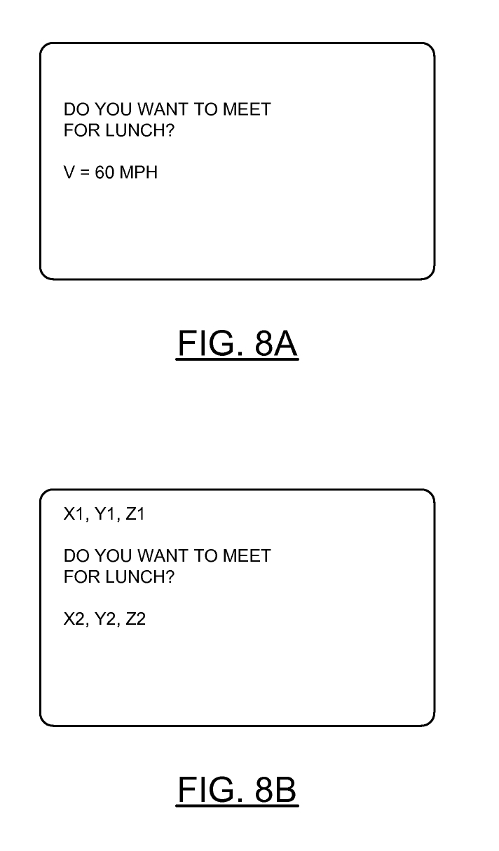

Referring to FIG. 4, a more detailed diagram of sub-steps of the step (or state) 216 is shown. The state 216 generally comprises the decision step (or state) 220, a step (or state) 222, a step (or state) 224, a step (or state) 226, and a step (or state) 228. The decision state 220 may determine if the send button on the device 100 has been pressed. If not, the method 216 moves to the state 228, where nothing is done. If the state 220 determines that the send button has been pressed, the step 222 may calculate an X, Y, and Z motion information position. Next, the step 224 appends the X, Y, and Z motion information to the electronic message. Next, the state 224 sends the electronic message along with the motion information (to be described in more detail in connection with FIGS. 8A and 8B).

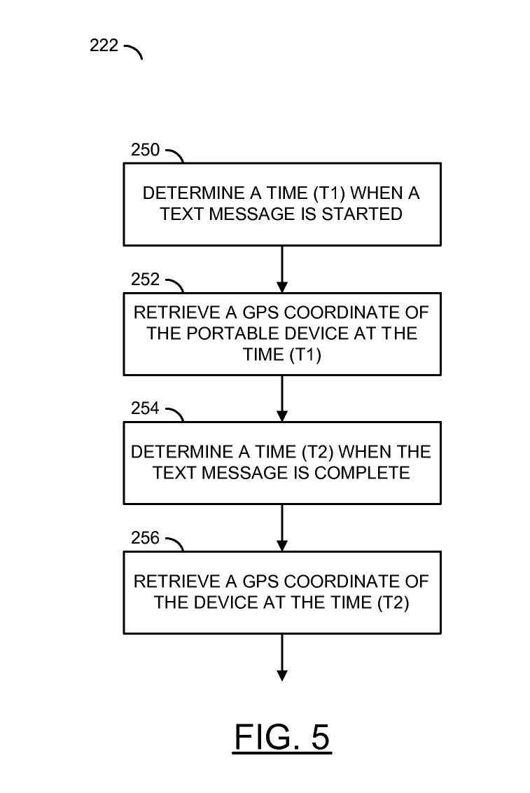

Referring to FIG. 5, one example of a number of sub-steps for the calculation step 222 of FIG. 4 is shown. The method 222 generally comprises a step (or state) 250, a step (or state) 252, a step (or state) 254 and a step (or state) 256. In the step 250, the method 222 determines a time T1 when an electronic message is started. For example, the time T1 may represent when a user of the device 100 begins the composition of a text message. The state 252 retrieves a GPS coordinate of the portable device 100 at the time T1. Next, the state 254 determines the time T2 when the text message is complete. The time T2 may be determined in a number of ways. For example, when a user presses a “send” button. In another example, the time T2 may be calculated after a predetermined time of no keystroke activity. Next, the state 256 retrieves a GPS coordinate of the device at the time T2. The GPS coordinate at the time T1 and the GPS coordinate at the time T2 may be used as motion information that is appended to the text message at the step 226.

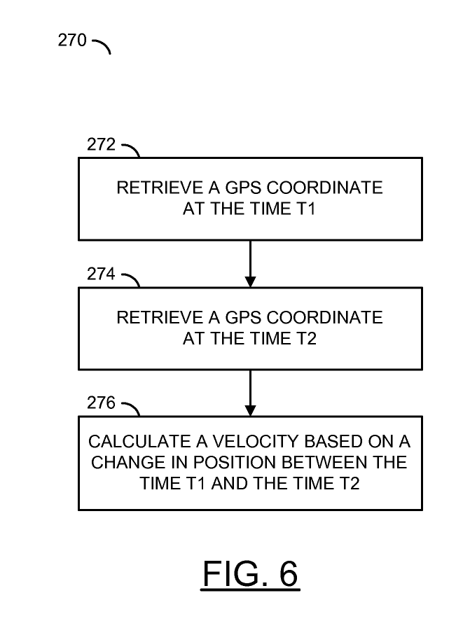

Referring to FIG. 6, a method (or process) 270 is shown as an alternate way to calculate the motion information in the step 222 of FIG. 4. The method 270 generally comprises a step (or state) 272, a step (or state) 274, and a step (or state) 276. In the step 272, the method retrieves a GPS coordinate at the time T1. In the step 274, the method retrieves a GPS coordinate at the time T2. Next, at the step 276, the method 270 calculates a velocity based on a changing of position between the time T1 and the time T2.

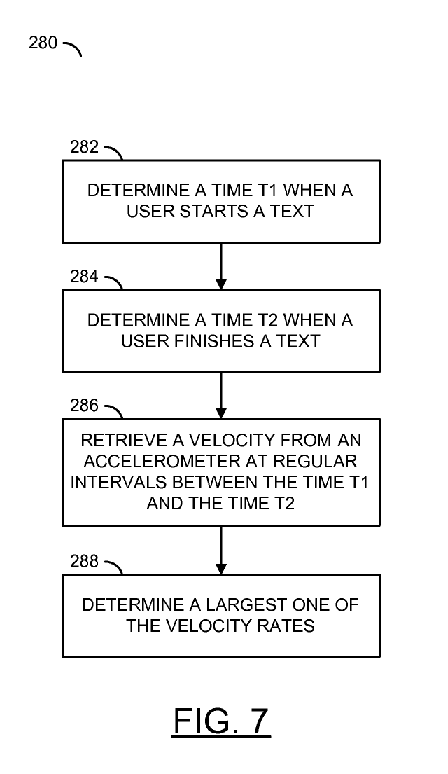

Referring to FIG. 7, a method (or process) 280 is shown as an alternate for calculating motion information in the step 222 of FIG. 4. The method 280 generally comprises a step (or state) 282, a step (or state) 284, a step (or state) 286 and a step (or state) 288. The step 282 determines a time T1 when the user starts the composition of an electronic message, for example. The step 284 determines a time T2 when the user finishes the electronic message. The step 286 may retrieve a number of velocity values (e.g., V1, V2, etc.) from the accelerometer 122 at regular intervals between the time T1 and the time T2. The step 288 may determine a largest one of the velocity values. In one example, the largest velocity value may be inserted into the text message.

Referring to FIGS. 8A and 8B, examples of electronic messages with embedded motion information are shown. In FIG. 8A, the message “Do you want to meet for lunch?” is shown at the beginning of the electronic message. A velocity value (e.g., “V=60 MPH”) is then inserted at the end of the electronic message. In the example of FIG. 8A, the calculation of the velocity value (an example of motion information) may be implemented in the processor 110. In the example in FIG. 8B, GPS position information may be included in the electronic message. For example, a first GPS location (e.g., “X1, Y1, Z1”) is shown on the first line. The second line shows the message composed by the user (e.g., “Do you want to meet for lunch?”). Next, a second GPS location (e.g., “X2, Y2, Z2”) is inserted at the end of the message. With the electronic message shown in FIG. 8B, the actual GPS coordinates are included in the message and routinely backed up by a cellular provider. In the example shown in FIG. 8A, any value greater than 0 MPH may be considered a red flag for an insurance adjuster. In the example shown in FIG. 8B, the additional GPS location information may be of value in forensically evaluating an accident situation.

In general, the electronic messages (or text messages) described, and the embedded motion information, may be in a format that is readable by a person using the device 100. For example, emotion information (e.g., smiley faces, etc.) may be readable by a person using the device 100 in a generally unencrypted format. GPS locations expressed in numbers may also be readable by a person. In general, the motion information may be readable by a person without the need for software. With such a presentation, an insurance adjuster and/or auditor may easily read the text and/or motion information from the device 100. Additionally, the electronic messaging and/or text information may be stored with backup systems that are routinely used to keep logs of normal text and/or electronic messages. No additional hardware and/or procedures may be needed at the cellular provider level.

Additionally, the device 100 may be modified to include an internal log of all of the text and/or electronic messages sent and/or received. Such an internal log may be downloaded and/or transmitted to another device located separately from the portable device 100. The log may be used, for example, to be submitted as an attachment along with insurance applications in order to qualify for a discount.

In another example, a timeout feature may be implemented to determine when a user simply stops composing an electronic message. For example, the device 100 may check for activity on the keys 104a-104n on a regular basis. In one example, the device 100 may check for activity on the keys 104a-104n every time the device 100 moves by a fixed distance (e.g., ½ mile, 1 mile, etc.). In such a scenario, if a user begins composing an electronic message, but does not send the message, the device 100 will determine that no activity on the keys 104a-104n occurred during the actual motion of the device 100. Such an implementation may avoid a scenario of reporting false movement during a delay situation.

The terms “may” and “generally” when used herein in conjunction with “is (are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to the preferred embodiments thereof, it will be understood by those skilled in the art that various changes in form and details may be made without departing from the scope of the invention.

1. An apparatus comprising:
an interface configured to allow a user to compose an electronic message; and
a control circuit configured to (i) receive motion information during a time when a user composes said electronic message and (ii) embed said motion information within said electronic message in a format readable along with said electronic message.

2. The apparatus according to claim 1, wherein said apparatus further comprises:
an antenna configured to receive said motion information from a cellular network.

3. The apparatus according to claim 2, wherein an antenna is configured to communicate with said cellular network, wherein said control circuit sends said electronic message to said cellular network.

4. The apparatus according to claim 1, wherein said apparatus further comprises:
an antenna configured to receive said motion information from a satellite network.

5. The apparatus according to claim 4, wherein said information comprises a plurality of GPS coordinates.

6. The apparatus according to claim 1, wherein said motion information comprises a plurality of velocity parameters at each of a plurality of times.

7. The apparatus according to claim 6, wherein said control circuit determines which of said velocity parameters has a highest value and embeds said highest value with said electronic message.

8. The apparatus according to claim 1, wherein said control circuit is configured to determine a velocity parameter at each of a plurality of times in response to a plurality of GPS coordinates.

9. The apparatus according to claim 1, wherein said control circuit (i) checks whether said message is being composed by checking for keyboard activity after said device moves a predetermined distance and (ii) presents a safe indication within said electronic message if no keyboard activity occurs.

10. The apparatus according to claim 1, wherein said control circuit saves a log of all electronics messages sent.

11. The apparatus according to claim 10, wherein said log is transmitted to an external device.

12. The apparatus according to claim 10, wherein said log is used in a calculation of insurance rates.

13. The apparatus according to claim 1, wherein said control circuit is configured to calculate a speed said apparatus is moving between a time when said user begins to compose said electronic message and a time when said user finishes said electronic message.

14. An apparatus comprising:
an antenna configured to communicate with a plurality of global positioning satellites (GPS) to receive a plurality of GPS coordinates;
an interface configured to allow a user to compose an electronic message; and
a control circuit configured to (i) receive a first GPS coordinate from said antenna when a user begins to compose said electronic message, (ii) receive a second GPS coordinate from said antenna when said user finishes composing said electronic message, and (iii) embed said first GPS coordinate and said second GPS coordinate within said electronic message in a format readable along with said electronic message.

15. The apparatus according to claim 14, wherein said apparatus further comprises:
a second antenna configured to communicate with a cellular network, wherein said control circuit sends said electronic message to said cellular network.

16. The apparatus according to claim 14, wherein said control circuit is configured to calculate a speed said apparatus is moving between a time when said user begins to compose said electronic message and a time when said user finishes said electronic message.

17. The apparatus according to claim 14, wherein said speed is appended to said electronic message.

18. The apparatus according to claim 14, wherein said electronic message comprises a short message service (SMS) compliant message.
